(19) United States
(12) Patent Application Publication
(10) Pub. No.: US 2005/0284726 A1
(43) Pub. Date: Dec. 29, 2005

(54) Centrifugally engaged drive sprocket assembly

(76) Inventor: Harry Bruce Crower, Jamul, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 10/876,949

(22) Filed: Jun. 24, 2004

(51) Int. Cl. F16D 23/10

(52) U.S. Cl. 192/105 C

(57) ABSTRACT

A centrifugally progressively engageable drive assembly for a vehicle such as a motorcycle or auto which employs a mechanical clutch to interrupt engine power to the transmission during gear changing and terms of vehicle idling. The device features a drive assembly engageable with the output shaft from an engine using an input component adapted for that engagement. The drive assembly has an output component adapted for engagement with a mechanical clutch conventionally employed for communicating or interrupting engine power to a transmission during driving. A centrifugal engagement of the input component to the output component as engine speed rises above a threshold rotational speed acts to disengage said input component from said output component when said rotational speed equals or falls below said threshold speed and increase power communication to the output component as engine speed rises progressively above the threshold speed. Operatively disposing the drive assembly between the output from the engine and its engagement to the clutch interrupts communication of power from said engine to said mechanical clutch when said engine is at or below said threshold rotational speed, thereby alleviating the need to hold said mechanical clutch in a position to disengage engine power from said transmission.

### BACKGROUND OF THE INVENTION

1. Field of the Invention

The present invention relates to a drive sprocket assembly for an internal combustion engine. More particularly it relates to a drive sprocket engaged upon the output or drive shaft of an internal combustion engine and rotationally communicating with the input shaft of a transmission which communicates engine power to the drive wheel of the vehicle on which the engine is mounted. The device as herein disclosed uses the varying circular or rotational velocity communicated from the drive shaft to which it is mounted, to engage a clutch to transmit variable engine force to thereby rotate a sprocket which communicates engine force to the input shaft of a transmission. This communication with the transmission input shaft can be direct or as in another preferred embodiment, through a manually operated transmission clutch. It is especially well adapted for use with motorcycles such as those manufactured by HARLEY DAVIDSON, which require constant shifting of gears during use to vary the torque imparted to the drive wheels depending on the current speed of the motorcycle. The disclosed device increases riding enjoyment through lessening the clutch and throttle use and dexterity on the part of the rider.

In a preferred embodiment, the disclosed device features a drive sprocket mechanism engaged with the manually operated clutch assembly which communicates varying amounts of engine force to rotate the transmission and drive wheel. The disclosed sprocket assembly is in mechanical communication with the conventional factory style manual clutch to thereby turn the transmission and\or drive wheel. The drive sprocket operably mounted on the sprocket assembly receives a variable amount of force communicated from the engine drive shaft depending on the rotational speed of the spline shaft which is rotationally engaged with the pressure plate of the sprocket assembly. The device in the disclosed embodiments is especially well suited to the limited confines of a motorcycle crankcase and equally well suited for mating directly with the transmission input shaft or a clutch engaged on the transmission input shaft.

2. Prior Art

Motorcycle engines in prior art generally employ a manually operated clutch mechanism to disconnect the input shaft on the transmission from the rotational power provided by output shaft or drive shaft from the motorcycle engine. The clutch is generally placed inline in the power train to receive the power generated by the engine directly from the outputting engine drive shaft. The clutch so engaged in the power train thereby provides the rider a mechanical means to disengage the engine power during shifting of the transmission to different gears or while sitting on the motorcycle or other vehicle to prevent it from moving when the engine is running.

However, such clutch systems, especially on larger heavy motorcycles, require great dexterity on the part of the rider. If the user releases the clutch too fast without increasing the fuel to the engine to increase its rotation rate and torque output, the engine will die due to the increased torque demands required to initiate movement from a standstill. Such mishaps are especially true of new riders of motorcycles or riders with varying weight loads on the motorcycle for rendering it difficult to compensate with the clutch and the fuel. Further, when stopped or sitting at long traffic lights, the physical act of holding the clutch in a disengaged position to interrupt engine power from reaching the transmission can be daunting even to the strongest hand.

Another vexing problem to the novice as well as experienced motorcycle and motor vehicle operators occurs when the vehicle comes to a stop on an uphill slant such as at a stop sign or red light signal. Many a driver has killed the engine when attempting to start forward again after a stop on an incline or hill due to the delicate balance required between the increased need for fuel to the engine to keep the engine from stalling when the clutch is fully disengaged and the unfamiliar increased rearward force generated on the vehicle by gravity. Too much fuel burns the clutch and too little fuel or too quick of a clutch release will cause the engine to stall.

U.S. Pat. No. 5,361,882 (Tipton) discloses a clutch lock-up system that is directly attached in line with the center axis of a mechanical clutch. The device features a plurality of cam fingers that rotate to move the factory pressure plate during increases and decreases in engine acceleration. However, Tipton is designed to work only concurrently with the factory clutch and does not regulate the torque communicated to it from the engine.

U.S. Publication number 2002/0063032 (Kumagai) also teaches a design for a clutch weight for a wet mechanical motorcycle centrifugal clutch. However, Kumagai employs the conventional brake drum style of centrifugal clutch and is not designed to be used in combination with a mechanical clutch.

U.S. Publication Number 2002/0185355 (Drussel) discloses an automatic clutch for automotive and other applications. Drussel is designed for attachment to the input shaft of the transmission as a replacement for a conventional manually activated clutch rather than for use in combination with the conventional clutch to regulate torque transmitted from the drive shaft of the engine.

U.S. Pat. No. 4,669,588 (Hayashi) teaches a single clutch component for use in a wet clutch system. The Hayashi clutch is not, however, designed for cooperative rotational engagement with a mechanical clutch engaged to the transmission but instead replaces it.

As such, there is a pressing need for a velocity or centrifugally engageable drive sprocket which will engage with the drive shaft or other output shaft from the engine, and regulate the amount of torque and power communicated to the input shaft of the transmission either directly or preferably through the mechanical clutch rotationally engaged with the input shaft of a transmission. Such a device should be operable in combination with the mechanical clutch communicating with the transmission and allow that clutch to operate normally when desired. Such a device should allow the engine of the motor vehicle to idle by interrupting the communication of engine rotational power to the mechanical clutch and thereby alleviate the need of the driver to physically hold the mechanical clutch in a disengaged state to conventionally separate the transmission from the engine rotation. Such a device should provide a regulated amount of torque to the mechanical clutch proportional to the velocity of the output shaft of the engine to which it is engaged by concurrently allowing for slippage during the initial start up of the vehicle from a standstill, to thereby aid the driver in avoiding stalling of the engine. Still further, such a device should be sufficiently compact that it will mount to the output shaft of a conventional engine in the confines already available, while employing the conventional means to transmit rotational power to the clutch assembly such as a belt, chain, or drive shaft.

### SUMMARY OF THE INVENTION

Applicant's device is a drive sprocket assembly which transmits engine power to a transmission or clutch and which is adapted for engagement along its center axis with the output shaft from an engine and in particular a motorcycle engine. The device employs a plurality of velocity sensitive actuators which operate to laterally translate a pressure plate along the center axis of the device between a retracted position out of communication with a drive plate, and an engaged position wherein the pressure plate is rotationally engaged with the drive plate. This lateral translation is provided by the actuators in direct proportion to engine speed communicated to the drive sprocket assembly from the output shaft of the engine.

Depending on the rotational speed of the engine drive shaft or output shaft, the plurality of actuators which are rotationally engaged on a slotted endplate will rotate from a static position wherein they allow the pressure plate to be biased away from the drive plate to a fully rotated position wherein the actuators act to force the pressure plate to a rotationally engaged communication with a drive plate.

The pressure plate is continually biased away from the drive plate along the center axis of the device by a means to bias the pressure plate which in a current preferred mode of the device employs springs engaged with projecting shafts on the pressure plate. Consequently, the pressure plate will default to a disengaged state from rotational communication with the drive plate when the engine is off or operating at a determined low RPM below a lower threshold such as when the engine idles. An increase in engine RPM above the lower threshold will directly increase the circular velocity of the slotted plate and force imparted by the actuators to overcome the rearward bias of the springs thereby causing lateral translation of the pressure plate toward the drive plate proportional to the increase in force.

As the pressure plate translates about the center axis of the device from the retracted position to the engaged position, varying amounts of rotation are imparted to the drive plate due to the varying amount of force imparted by the actuators to translate the pressure plate. This imparted force varies according to the rotational speed of the output shaft which communicates engine force to the slotted plate to rotate it at differing velocities. As engine speed increases from idle to low speed, the actuators will translate the pressure plate a distance such that minimal rotational force is imparted to the drive plate while slippage concurrently occurs between the pressure plate and drive plate. As the rotational speed of the output shaft and connected slotted plate increases, the amount of force imparted by the actuators to translate the pressure plate and overcome the rearward bias of the spring increases. As this force increases, the rotation imparted to the drive plate increases and slippage decreases thereby causing a regulated and smooth transition from idle speed to operating speed. At a certain rotation speed of the engine the actuators will act with sufficient force to totally overcome the rearward bias of the springs and to translate the pressure plate along the center axis with sufficient force to a lock up engagement with the drive plate wherein slippage ceases and the rotational velocity of the output shaft, slotted plate, and drive plate are all substantially equal.

In placing a centrifugally activated drive sprocket in communication between the manual clutch and the output shaft of the engine, the user is provided with heretofore unobtainable convenience in that the rotational engine power is only transmitted to the clutch above the lower RPM threshold. This transfer is also proportional to engine speed. Consequently, the user has the utility of a centrifugally engaged drive sprocket providing the power to a clutch which can still be manually operated. Generally, users have had to choose either a manual clutch or a centrifugal clutch but were not afforded a choice of both.

In a preferred mode of the device, at least one friction disk and one floating plate are disposed between the drive plate and the pressure plate. Preferably a plurality of friction disks and a plurality of float plates are so disposed. This arrangement provides for smoother operation of the device during translation of the pressure plate toward and away from the drive plate by providing a much larger area for engagement and transmission of the engine force from pressure plate to the drive plate and the same amount of area for the required slippage to regulate the power transmitted at start-up.

Using this arrangement, the floating plates are translatably engaged on the drive plate such that they will translate about the center axis of the assembly. However, the floating plates are engaged with the drive plate such that they rotate at substantially the same speed as the drive plate at all times. The friction disks are situated between the floating plates and the pressure plate. As noted these floating plates provide a large surface area to impart both frictional engagement with the floating plates, as well as slippage in that engagement, depending on the rotational speed imparted to the slotted plate by the output shaft of the engine. It has been observed that at least two friction disks and an equal number of floating plates provide an especially smooth operation of the device. Of course those skilled in the art will no doubt realize that more or less of the floating plates and friction disks can be used, or on an embodiment of the device that might function less smoothly, no such floating plates and friction disks might be employed. As such, any construction of the device which employs more, less, or no friction and floating plates, is considered within the scope of this invention. However, the current preferred mode of the device employs at least one friction disk and floating plate and preferably a plurality of each for smoother operation.

In an arrangement as would be conventionally found in a motorcycle, a sprocket is engaged with the drive plate around the center axis of the device. This sprocket will of course also rotate at the same speed as the drive plate and is adapted for engagement with the clutch engaged on the input shaft of the transmission. Generally in a motorcycle such an engagement is accomplished using a belt or a chain or drive shaft.

Using this arrangement, the device provides the rider with exceptional control and convenience whether idling or during riding and shifting. This is because when the engine is idling at a low speed, the pressure plate disengages from imparting any rotation to the drive plate and thus the sprocket does not rotate and imparts no force to the clutch. Since no input force from the idling engine is received by the clutch, it need not be kept depressed when the motorcycle is stationary at a stoplight. As the rider begins to transition from a stationary position to moving, the device will impart a regulated amount of force to the clutch depending on the speed of the engine output shaft in communication with the slotted hub which will cause the pressure such, any construction of the device which employs more, less, or no friction and floating plates, is considered within the scope of this invention. However, the current preferred mode of the device employs at least one friction disk and floating plate and preferably a plurality of each for smoother operation.

In an arrangement as would be conventionally found in a motorcycle, a sprocket is engaged with the drive plate around the center axis of the device. This sprocket will of course also rotate at the same speed as the drive plate and is adapted for engagement with the clutch engaged on the input shaft of the transmission. Generally in a motorcycle such an engagement is accomplished using a belt or a chain or drive shaft.

Using this arrangement, the device provides the rider with exceptional control and convenience whether idling or during riding and shifting. This is because when the engine is idling at a low speed, the pressure plate disengages from imparting any rotation to the drive plate and thus the sprocket does not rotate and imparts no force to the clutch. Since no input force from the idling engine is received by the clutch, it need not be kept depressed when the motorcycle is stationary at a stoplight. As the rider begins to transition from a stationary position to moving, the device will impart a regulated amount of force to the clutch depending on the speed of the engine output shaft in communication with the slotted hub which will cause the pressure plate to slippedly engage with the drive plate as the rider takes off. The pressure plate, moving from the default disengaged position over a mass and velocity regulated time period to a lock up with the fiction disks and floating plates sandwiched between the pressure plate and drive plate, regulates the power from the engine transmitted to the clutch or transmission.

As those skilled in the art might realize, because of this varying and self-regulating force imparted to the drive plate and connected sprocket, in theory a clutch may not be necessary for the rider since the disclosed device will provide an automatic clutch. However, it has been found that when used in combination with a manually operated clutch, the rider enjoys both the regulated output of power from the engine to the transmission as well as the ability to still operate the mechanical clutch during shifting. This combination of a drive sprocket which communicates engine force to the mechanical clutch depending on engine output shaft velocity virtually eliminates stalling caused on hills and because of inexperienced riders as is conventionally experienced in vehicles where the drive sprocket communicating power to the clutch is directly engaged to the engine output shaft. By employing such a sprocket that regulates the power input to the clutch engaged to the transmission, rider fatigue and mistakes are significantly decreased thereby causing an increase in rider enjoyment.

With respect to the above description, before explaining at least one preferred embodiment of the invention in detail, it is to be understood that the invention is not limited in its application to the details of construction and to the arrangement of the components or steps set forth in the following description or illustrated in the drawings, nor just to motorcycle. The apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the objects and claims be regarded as including such equivalent construction and methodology insofar as they do not depart from the spirit and scope of the present invention.

It is an object of this invention to provide centrifugally engageable drive sprocket which will engage with the drive shaft or other output shaft from the engine and regulate the amount of torque and power communicated to a mechanical clutch rotationally engaged with the input shaft of a transmission.

Another objective of this invention is to provide such a centrifugally engageable drive sprocket which will operate in combination with the mechanical clutch communicating with the transmission concurrently allowing normal mechanical clutch operation.

An additional objective of this invention is to provide a centrifugally engageable drive sprocket which will interrupt the communication of engine rotational power to the mechanical clutch during idle of the engine thereby alleviating the requirement to physically hold the mechanical clutch in a disengaged state.

A still further object of this invention is the provision of a centrifugally engageable drive sprocket that provides a regulated amount of torque to the mechanical clutch or transmission depending on the revolutions of the engine to which is engaged, while concurrently allowing for slippage during initial start up of the vehicle from a standstill to thereby aid the driver in avoiding stalling of the engine.

Yet another object of this invention is such a device which is sufficiently compact that it will engage with the output shaft of a conventional engine in the confines already available, and can employ the conventional means to transmit rotational power to the clutch assembly such as a belt, chain, or drive shaft.

Further objectives of this invention will be brought out in the following part of the specification, wherein detailed description is for the purpose of fully disclosing the invention without placing limitations thereon.

### BRIEF DESCRIPTION OF DRAWING FIGURES

FIG. 1 is a side cut away view of the disclosed device adapted for mounting on a motorcycle engine output shaft.

FIG. 2 is a perspective exploded view the disclosed device depicting showing the components of the centrifugally engageable drive sprocket along a center axis.

FIG. 3 is a top view of the endplate component of the disclosed device showing the plurality of mounted actuators.

FIG. 4 is a side cut away view along line 4-4.

FIG. 5 depicts a top view of the friction disk.

FIG. 6 is a side view of the friction disk.

FIG. 7 is a top view of the floating plate.

FIG. 8 is a side view of the floating plate.

FIG. 9 depicts another preferred embodiment of the actuators employed to translate the pressure plate.

FIG. 10 depicts another preferred embodiment of the actuators employed to translate the pressure plate.

### DETAILED DESCRIPTION OF PREFERRED EMBODIMENTS OF THE DISCLOSED DEVICE

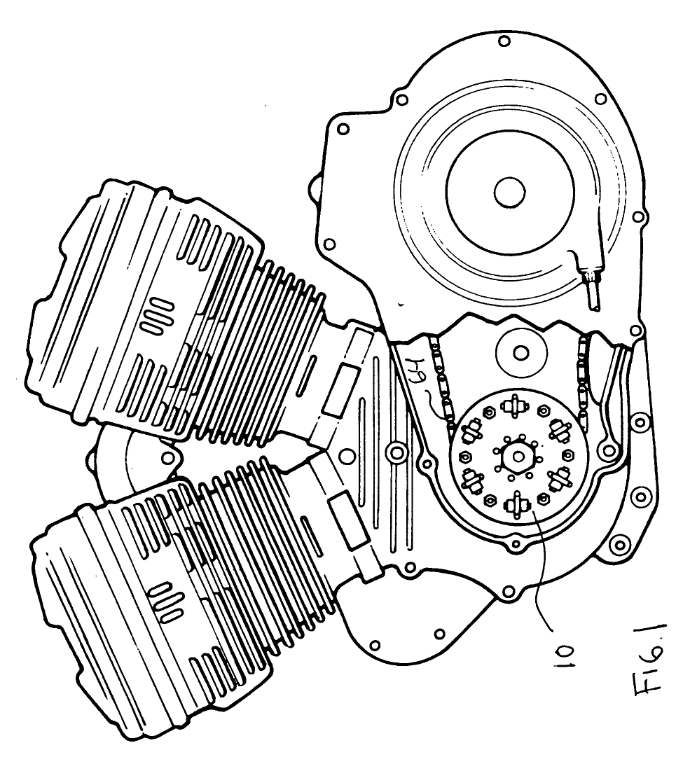

Referring now to the drawings FIGS. 1-10 disclose the preferred embodiments of the herein disclosed centrifugally engaged drive sprocket assembly device 10, FIG. 1 depicts an exploded view of the device 10 along center axis 11.

As shown in FIG. 1, the device 10 is adapted for fixed engagement with the output shaft 12 from an engine and in particular a motorcycle engine as shown in FIG. 10. An endplate 14 is fixedly engaged to the output shaft 12 using means for engagement such as nut 16 whereby the endplate 14 rotates at the same speed as the output shaft 14. The fixed engagement is ensured by the cooperating splines 18 on both the output shaft 12 and within a centered aperture of the endplate 14.

A pressure plate 20 is translatably engaged to the endplate 14 such that it will translate between a first position closest to the endplate 14 and furthest from the drive plate 24, and a second position closest to the drive plate 24. As can be seen in FIG. 1, the drive plate 24 is mounted on its center aperture 24 such that it rotates about the center axis 11 but not fixedly engaged to the output shaft 12. This mounting can be further facilitated by a bearing in the center aperture 24 that rides on a bearing surface 26 about the output shaft 12 however any means to engage the drive plate 22 for independent rotation about the center axis 11 when disengaged from contact force from the pressure plate 20 will provide for the independent rotation of the drive plate 22.

The pressure plate 20 is translatably engaged with the endplate 14 in a current preferred mode of the device 10 using studs 28 which slidably engage in registered apertures 30 communicating through the endplate 14 from the first side to the second side of the endplate 14. As a means to bias the pressure plate 20 to the first position closest to the endplate 14, springs 32 are engaged around the studs 14 when projecting thorough the endplate 14 and are compressed by spring nuts 36. This compression of the spring 32 naturally biases the studs 28 and connected pressure plate 20 to the first position. A means of adjusting the bias of the pressure plate toward the first position is provided by one or a combination of changing the size or compression resistance of the spring, or adjusting the spring nuts 36 to points closer or further from the pressure plate 20 thereby varying the amount of biasing force exerted by the springs 32 on the pressure plate. Changing the force of the spring 32 also allows for a means to adjust the timing of the pressure plate 20 moving from the first position to the second position since more or less force is required to translate the pressure plate 20 and it takes more or less time for the velocity of the endplate to force the mass of the weights 50 to their ultimate positions.

As can be seen, the pressure plate 20 will naturally default to the first position due to the bias imparted thereon. This first position should be sufficiently distant from the drive plate 22 where little if any rotational force from the pressure plate 20 is transmitted to the drive plate 22. In the current preferred mode of the device 10 sandwiched along the center axis 11 between the pressure plate 20 and the drive plate 22 are at least one friction disk 54 and one floating plate 56. Consequently the first position of the pressure plate 20 needs to accommodate any other components sandwiched between the pressure plate 20 and the drive plate 22 and still impart little of no rotational force to the drive plate 22.

As a means to translate the pressure plate 20 toward the drive plate 22 a distance in proportion to the rotational speed of the output shaft 12 or connected endplate 14, a plurality of actuators 42 are engaged on the endplate 14 and act to contact and translate the pressure plate 20 toward and to the second position as engine speed and hence endplate 14 rotational velocity increases.

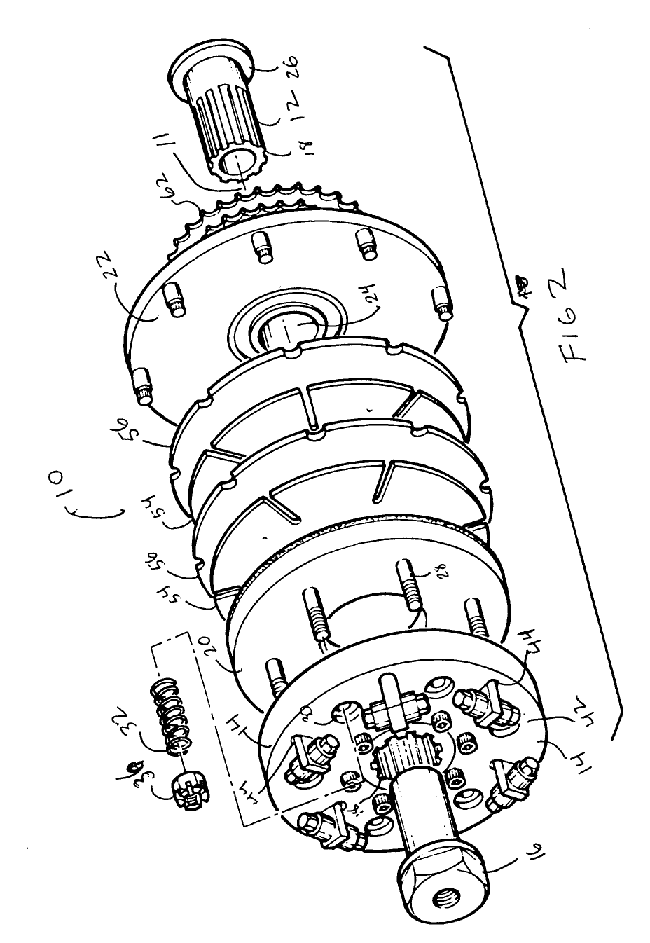

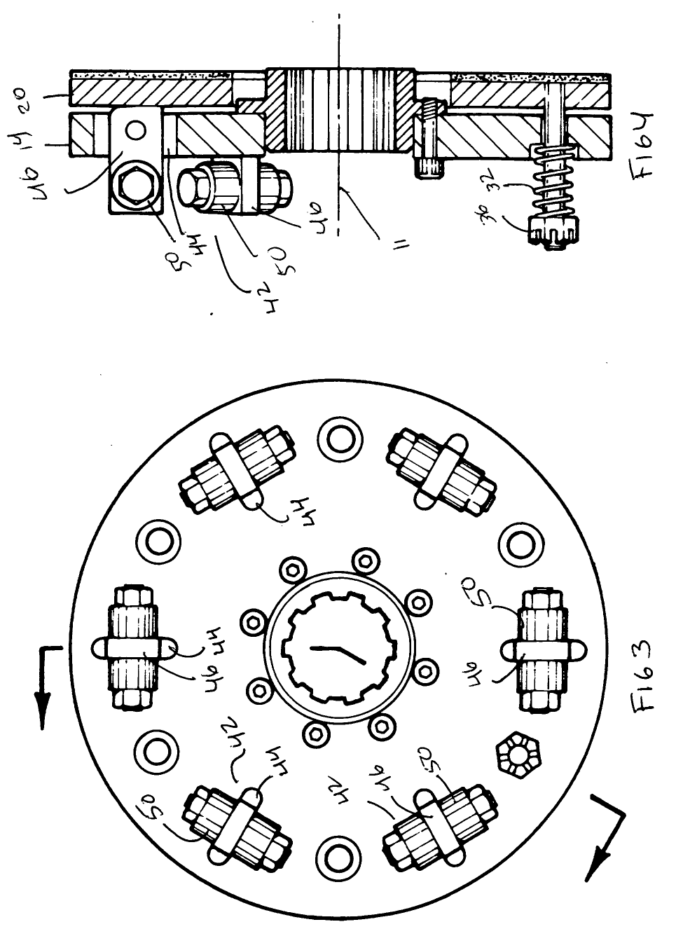

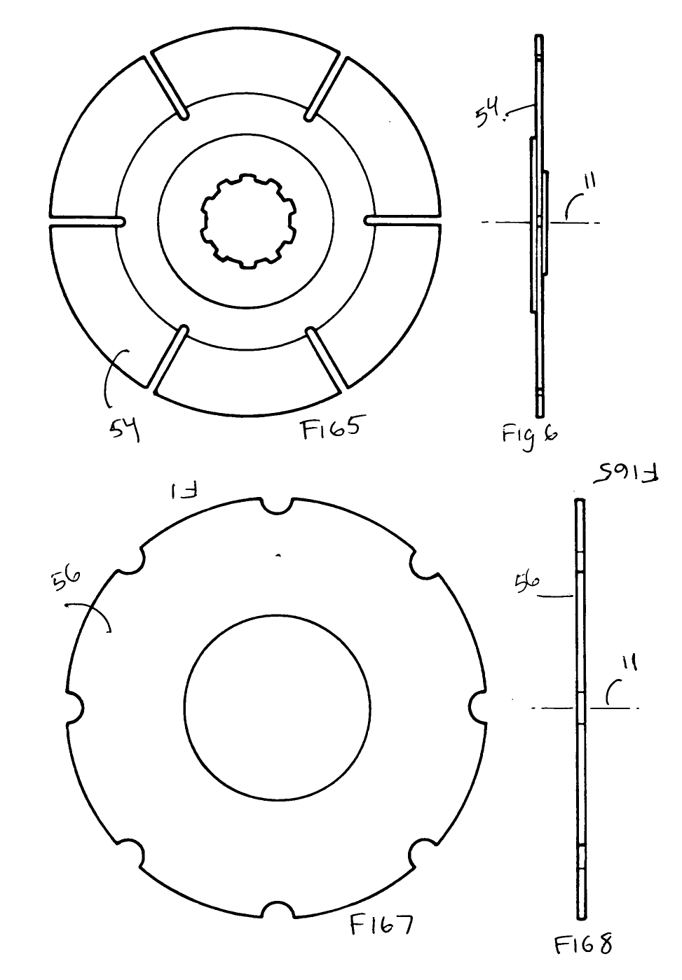

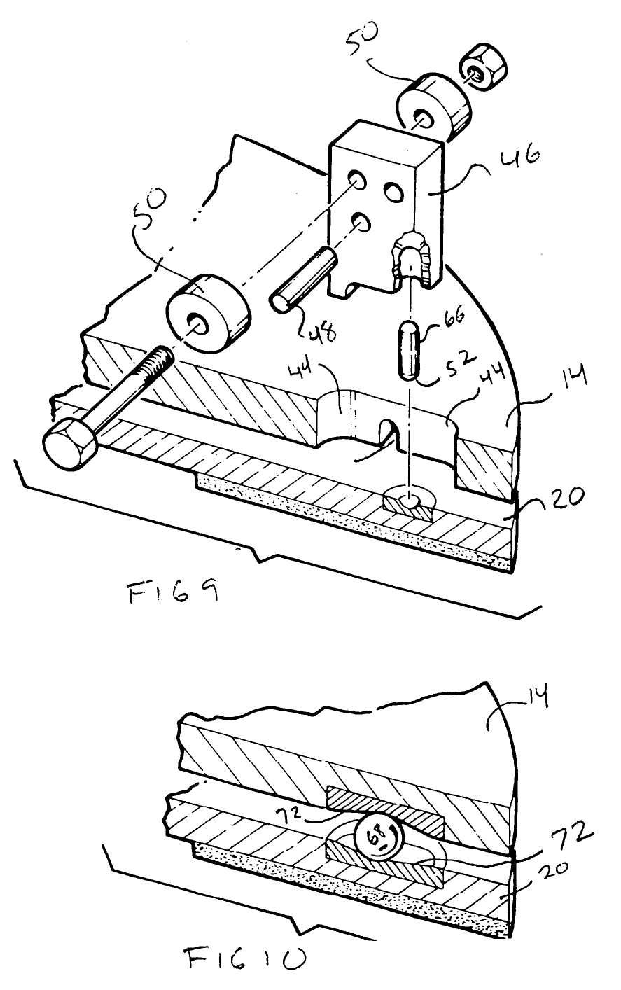

As best shown in FIGS. 3 and 4, a first preferred embodiment of the actuators 42 is shown. This embodiment features slots 44 formed through the endplate 14 dimensioned to accommodate a lever 46 rotationally engaged on a pin 48 adjacent to an engagement end of the lever 46. On the distal end of the lever 14 is engaged a weight 50 which functions to rotate the lever 46 on the pin 48 with increasing force as proportionate to the rotational velocity of the endplate 14. As that force increases with the velocity of the endplate 14 the levers 14 rotate toward the exterior circumference of the endplate and a contact surface 54 on the outside corner of the lever 46 forces the pressure plate 20 toward the second position closest to the drive plate 22 in proportion to the increase in rotational acceleration of the endplate 14. The lever 46 will contact the edge of the slot 14 thereby determining a maximum amount of rotation of the lever 46 toward the exterior circumference of the endplate 14. At this point the contact surface 52 will have contacted the exterior surface of the pressure plate and translated it to the second position closest to the drive plate 22. The mass of the weights 50 serves to not only provide the force necessary to rotate the lever 46 in contact with the biases pressure plate 22. Changing the mass of the weight 50 and mounting hardware to a lighter weight or total mass decreases the force the pressure plate 22 will impart to the drive plate 22 when in the second position. Conversely, changing to a heaver mass will increase the force. Therefore changing the mass of the weights 50 provides a means to adjust the force imparted from the pressure plate 22 to the drive plate 22. Further, changing the mass to a heavier mass will decrease the time it takes to move the pressure plate from the first position to the second position placing maximum force on the drive plate and conversely lessening the mass will increase that time. Therefore adjusting the mass of the weights 50 also provides a means to vary the time for the pressure plate to communicate with the drive plate 22 in a locked up engagement. As noted, in a preferred mode of the device, at least one friction disk 54 and one floating plate 56 are disposed between the drive plate 22 and the pressure plate 20 about the center axis 11. Preferably a plurality of friction disks 54 and a plurality of float plates 56 are so disposed as shown in FIG. 1. The floating plates 56 are translatably engaged to the drive plate such that they will translate about the center axis 11 of the assembly such that they rotate at substantially the same speed as the drive plate 22 at all times. This translatable engagement is shown with drive plate studs 58 engaging in slots 60 formed in the exterior circumference of the floating plates 56. This engagement will transmit any force imparted to the floating plates 58 from the pressure plate 20 to the drive plate 22. The friction disks 54 are disposed between the floating plates 56 or between one floating plate 56 and the pressure plate 20. As noted this plurality of friction plates and floating plates provide a large surface area to impart both frictional engagement as slippage in that engagement depending on the position of the pressure plate 20 between the first position and second position smoothing the operation of the device 10.

A means to communicate rotational power from the drive plate 22 to the conventional clutch (not shown) or directly to the transmission as would be conventionally found in a motorcycle, is provided as shown by a sprocket 62 which is in fixed engagement with the drive plate 22. As noted, generally in a motorcycle, such an engagement is accomplished using a belt or a chain 64 or drive shaft.

Another preferred means to translate the pressure plate 20 toward the drive plate 22 a distance in proportion to the rotational speed of the output shaft 12 is shown in FIG. 9. In this embodiment the lever 46 has a weight 50 which has a combined mass of the weights 50 and the mounting hardware engaging it to the lever 46. Changing this mass will alter the performance characteristics as noted above. The contact surface 52 is provided by a translating pin 66 engaged with the lever 46 such that rotation of the lever 46 noted above will force the translating pin 66 against the pressure plate 20. This embodiment is preferred as it reduces the space occupied by the device 10.

Yet another preferred means to translate the pressure plate 20 toward the drive plate 22 a distance in proportion to the rotational speed of the output shaft 12 is shown in FIG. 10. In this embodiment a ball 68 is engaged in a cooperating elongated passage 70 defined by elongated detents 72 formed in opposing wall surfaces of the endplate 14 and he pressure plate 20. The wall surface of one of the detents 72 slats at an angle toward the gap between the endplate 14 and pressure plate 20. Much like the lever 46 with weight 50 as the rotational velocity of the endplate 14 increases, the ball 68 is forced outward at a force proportional to its mass times the increase in velocity and contacts the angled surface of one of the detents 72 thereby forcing the pressure plate 20 toward the second position. Changing the mass of the ball 68 has the same effect on timing and force exerted noted above as changing the mass of the weights 50 and mounting hardware for the weights 50.

Although the invention has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications as would occur to those skilled in the art, are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

1. A drive assembly for a vehicle comprising:
an endplate, said endplate, said endplate adapted for cooperative engagement on an output shaft from an engine;
a center axis running through said output shaft and said endplate;
a drive plate, said drive plate rotatably engaged about said center axis;
a pressure plate translatably engaged with said endplate, said pressure plate translatable between a first position closest to said endplate, and a second position, closest to said drive plate;
means continually to bias said pressure plate toward said first position;
means to bias said pressure plate a distance toward drive plate to a translated position along said axis from said first position to said second position;
said translated position having a proximity to said second position proportional to the speed of rotation of said output shaft above a lower threshold speed;
said pressure plate only communicating rotational power from said output shaft to said drive plate when said output shaft rotates above said threshold speed and substantially interrupting communication of said rotational power when said output shaft rotates below said threshold speed; and
said drive plate adapted to communicate said rotational power communicated from said pressure plate, to a clutch engaged with the input shaft of a transmission.

2. The drive assembly for vehicles of claim 1 additionally comprising:
said vehicle being a motorcycle, and
said clutch being manually operable by a rider.

3. The drive assembly for vehicles of claim 1 additionally comprising:
at least one floating plate disposed about said axis between said drive plate and said pressure plate;
said floating plate translatably engaged with said drive plate to translate along said center axis; and
at least one friction disk, rotationally engaged about said center axis between said floating plate and said pressure plate.

4. The drive assembly for vehicles of claim 2 additionally comprising:
at least one floating plate disposed about said axis between said drive plate and said pressure plate;
said floating plate translatably engaged with said drive plate to translate along said center axis; and
at least one friction disk, rotationally engaged about said center axis between said floating plate and said pressure plate.

5. The drive assembly for vehicles of claim 1 additionally comprising:
a plurality of said floating plates disposed about said axis between said drive plate and said pressure plate;
each of said floating plates translatably engaged with said drive plate to translate along said center axis; and
a plurality of said friction disks, at least one of said plurality of friction disks engaged between every adjacent pair of said plurality of floating plates; and
at least one of said plurality of friction disks disposed between said pressure plate and any adjacent of said plurality of floating plates.

6. The drive assembly for vehicles of claim 2 additionally comprising:
a plurality of said floating plates disposed about said axis between said drive plate and said pressure plate;
each of said floating plates translatably engaged with said drive plate and to translate along said center axis; and
a plurality of said friction disks, at least one of said plurality of friction disks engaged between every adjacent pair of said plurality of floating plates; and
at least one of said plurality of friction disks disposed between said pressure plate and any adjacent of said plurality of floating plates.

7. The drive assembly for vehicles of claim 1 wherein said means continually to bias said pressure plate toward said first position comprises:
said pressure plate translatably engaged with said endplate by a plurality of adjustment bolts engaged with said pressure plate and communicating through apertures in said endplate; and
each of said abutment bolts having a spring on its respective distal end, said spring biasing against a side of said endplate.

8. The drive assembly for vehicles of claim 3 wherein said means continually to bias said pressure plate toward said first position comprises:
said pressure plate translatably engaged with said endplate by a plurality of adjustment bolts engaged with said pressure plate and communicating through apertures in said endplate; and
each of said abutment bolts having a spring on its respective distal end, said spring biasing against a side of said endplate.

9. The drive assembly for vehicles of claim 5 wherein said means continually to bias said pressure plate toward said first position comprises:
said pressure plate translatably engaged with said endplate by a plurality of adjustment bolts engaged with said pressure plate and communicating through apertures in said endplate; and
each of said abutment bolts having a spring on its respective distal end, said spring biasing against a side of said endplate.

10. The drive assembly for vehicles of claim 6 wherein said means continually to bias said pressure plate toward said first position comprises:
said pressure plate translatably engaged with said endplate by a plurality of adjustment bolts engaged with said pressure plate and communicating through apertures in said endplate; and
each of said abutment bolts having a spring on its respective distal end, said spring biasing against a side of said endplate.

11. The drive assembly for vehicles of claim 4 wherein said means continually to bias said pressure plate toward said first position comprises:
said pressure plate translatably engaged with said endplate by a plurality of adjustment bolts engaged with said pressure plate and communicating through apertures in said endplate; and
each of said abutment bolts having a spring on its respective distal end, said spring biasing against a side of said endplate.

12. The drive assembly for vehicles of claim 1 wherein said means to bias said pressure plate a distance toward drive plate to a translated position comprises:
a plurality of slots communicating through said endplate;
a lever rotationally engaged in each slot adjacent to a contact end, and having a distal end projecting from said endplate opposite said contact end;
a weight engaged on said distal end of said lever;
said lever rotating to a first position through biased engagement with said pressure plate on said contact end when said rotation of said output shaft is equal to or less than said lower threshold speed; and
said lever rotating to a second position translating said pressure plate toward said second position when said rotation of said output shaft exceeds said lower threshold speed.

13. The drive assembly for vehicles of claim 3 wherein said means to bias said pressure plate a distance toward drive plate to a translated position comprises:
a plurality of slots communicating through said endplate;
a lever rotationally engaged in each slot adjacent to a contact end, and having a distal end projecting from said endplate opposite said contact end;
a weight engaged on said distal end of said lever;
said lever rotating to a first position through biased engagement with said pressure plate on said contact end when said rotation of said output shaft is equal to or less than said lower threshold speed; and
said lever rotating to a second position translating said pressure plate toward said second position when said rotation of said output shaft exceeds said lower threshold speed.

14. The drive assembly for vehicles of claim 5 wherein said means to bias said pressure plate a distance toward drive plate to a translated position comprises:
a plurality of slots communicating through said endplate;
a lever rotationally engaged in each slot adjacent to a contact end, and having a distal end projecting from said endplate opposite said contact end;
a weight engaged on said distal end of said lever;
said lever rotating to a first position through biased engagement with said pressure plate on said contact end when said rotation of said output shaft is equal to or less than said lower threshold speed; and
said lever rotating to a second position translating said pressure plate toward said second position when said rotation of said output shaft exceeds said lower threshold speed.

15. The drive assembly for vehicles of claim 7 wherein said means to bias said pressure plate a distance toward drive plate to a translated position comprises:
a plurality of slots communicating through said endplate;
a lever rotationally engaged in each slot adjacent to a contact end, and having a distal end projecting from said endplate opposite said contact end;
a weight engaged on said distal end of said lever;
said lever rotating to a first position through biased engagement with said pressure plate on said contact end when said rotation of said output shaft is equal to or less than said lower threshold speed; and
said lever rotating to a second position translating said pressure plate toward said second position when said rotation of said output shaft exceeds said lower threshold speed.

16. The drive assembly for vehicles of claim 10 wherein said means to bias said pressure plate a distance toward drive plate to a translated position comprises:
a plurality of slots communicating through said endplate;
a lever rotationally engaged in each slot adjacent to a contact end, and having a distal end projecting from said endplate opposite said contact end;
a weight engaged on said distal end of said lever;
said lever rotating to a first position through biased engagement with said pressure plate on said contact end when said rotation of said output shaft is equal to or less than said lower threshold speed; and
said lever rotating to a second position translating said pressure plate toward said second position when said rotation of said output shaft exceeds said lower threshold speed.

17. The drive assembly for vehicles of claim 11 wherein said means to bias said pressure plate a distance toward drive plate to a translated position comprises:
a plurality of slots communicating through said endplate;
a lever rotationally engaged in each slot adjacent to a contact end, and having a distal end projecting from said endplate opposite said contact end;
a weight engaged on said distal end of said lever;
said lever rotating to a first position through biased engagement with said pressure plate on said contact end when said rotation of said output shaft is equal to or less than said lower threshold speed; and
said lever rotating to a second position translating said pressure plate toward said second position when said rotation of said output shaft exceeds said lower threshold speed.

18. The drive assembly for vehicles of claim 12 wherein said means to bias said pressure plate a distance toward drive plate to a translated position additionally comprises:
a pin slidably engaged in a slot disposed in said contact end of said lever; and
said pin projecting from said slot at a first end having a contact point;
said contact point in communication with said pressure plate.

19. The drive assembly for vehicles of claim 13 wherein said means to bias said pressure plate a distance toward drive plate to a translated position additionally comprises:
a pin slidably engaged in a slot disposed in said contact end of said lever; and
said pin projecting from said slot at a first end having a contact point;
said contact point in communication with said pressure plate.

20. The drive assembly for vehicles of claim 14 wherein said means to bias said pressure plate a distance toward drive plate to a translated position additionally comprises:
a pin slidably engaged in a slot disposed in said contact end of said lever; and
said pin projecting from said slot at a first end having a contact point;
said contact point in communication with said pressure plate.

21. The drive assembly for vehicles of claim 1 wherein said means to bias said pressure plate a distance toward drive plate to a translated position additionally comprises:
a plurality of elongated first recesses formed in the surface of said endplate, each of said elongated recesses having a first end closest to said center axis and a distal end opposite said first end and a first surface in-between said first end and said second end;
a plurality of second elongated recesses formed in the surface of said pressure plate, said plurality of second elongated recesses positioned to be immediately opposite said plurality of first recesses when said endplate is mounted in an operative position adjacent to said pressure plate, each of said plurality of second elongated recesses having a first end and a distal end opposite said first end and a first surface in-between said first end and said second end;
said first surface of said first recess becoming closer to the first surface of said second recess at their respective distal ends; and
a ball engaged within each of said opposing first recesses and said second recesses;
said ball having a diameter equal to or smaller than the distance between the respective first surfaces of said respective recesses at their opposing respective first ends;
said ball having a diameter larger than the distance between the respective first surfaces of said respective recesses at their opposing respective distal ends, whereby said ball is forced into engagement with said first surface of said first recess and said first surface of said second recess adjacent to their respective distal ends progressively as said rotation of said output shaft rises above said lower threshold speed, thereby translating said pressure plate toward said second position a distance proportional to the speed of rotation of said output shaft above said lower threshold speed.

22. The drive assembly for vehicles of claim 5 wherein said means to bias said pressure plate a distance toward drive plate to a translated position additionally comprises:
a plurality of elongated first recesses formed in the surface of said endplate, each of said elongated recesses having a first end closest to said center axis and a distal end opposite said first end and a first surface in-between said first end and said second end;
a plurality of second elongated recesses formed in the surface of said pressure plate, said plurality of second elongated recesses positioned to be immediately opposite said plurality of first recesses when said endplate is mounted in an operative position adjacent to said pressure plate, each of said plurality of second elongated recesses having a first end and a distal end opposite said first end and a first surface in-between said first end and said second end;
said first surface of said first recess becoming closer to the first surface of said second recess at their respective distal ends;
a ball engaged within each of said opposing first recesses and said second recesses;
said ball having a diamater equal to or smaller than the distance between the respective first surfaces of said respective recesses at their opposing respective first ends; and
said ball having a diamater larger than the distance between the respective first surfaces of said respective recesses at their opposing respective distal ends, whereby said ball is forced into engagement with said first surface of said first recess and said first surface of said second recess adjacent to their respective distal ends progressively as said rotation of said output shaft rises above said lower threshold speed, thereby translating said pressure plate toward said second position a distance proportional to the speed of rotation of said output shaft above said lower threshold speed.

23. The drive assembly for vehicles of claim 7 wherein said means to bias said pressure plate a distance toward drive plate to a translated position additionally comprises:
a plurality of elongated first recesses formed in the surface of said endplate, each of said elongated recesses having a first end closest to said center axis and a distal end opposite said first end and a first surface in-between said first end and said second end;
a plurality of second elongated recesses formed in the surface of said pressure plate, said plurality of second elongated recesses positioned to be immediately opposite said plurality of first recesses when said endplate is mounted in an operative position adjacent to said pressure plate, each of said plurality of second elongated recesses having a first end and a distal end opposite said first end and a first surface in-between said first end and said second end;
said first surface of said first recess becoming closer to the first surface of said second recess at their respective distal ends;
a ball engaged within each of said opposing first recesses and said second recesses;
said ball having a diamater equal to or smaller than the distance between the respective first surfaces of said respective recesses at their opposing respective first ends; and
said ball having a diamater larger than the distance between the respective first surfaces of said respective recesses at their opposing respective distal ends, whereby said ball is forced into engagement with said first surface of said first recess and said first surface of said second recess adjacent to their respective distal ends progressively as said rotation of said output shaft rises above said lower threshold speed, thereby translating said pressure plate toward said second position a distance proportional to the speed of rotation of said output shaft above said lower threshold speed.

24. The drive assembly for vehicles of claim 3 wherein said means to bias said pressure plate a distance toward drive plate to a translated position additionally comprises:
a plurality of elongated first recesses formed in the surface of said endplate, each of said elongated recesses having a first end closest to said center axis and a distal end opposite said first end and a first surface in-between said first end and said second end;
a plurality of second elongated recesses formed in the surface of said pressure plate, said plurality of second elongated recesses positioned to be immediately opposite said plurality of first recesses when said endplate is mounted in an operative position adjacent to said pressure plate, each of said plurality of second elongated recesses having a first end and a distal end opposite said first end and a first surface in-between said first end and said second end;
said first surface of said first recess becoming closer to the first surface of said second recess at their respective distal ends;
a ball engaged within each of said opposing first recesses and said second recesses;
said ball having a diamater equal to or smaller than the distance between the respective first surfaces of said respective recesses at their opposing respective first ends; and
said ball having a diamater larger than the distance between the respective first surfaces of said respective recesses at their opposing respective distal ends, whereby said ball is forced into engagement with said first surface of said first recess and said first surface of said second recess adjacent to their respective distal ends progressively as said rotation of said output shaft rises above said lower threshold speed, thereby translating said pressure plate toward said second position a distance proportional to the speed of rotation of said output shaft above said lower threshold speed.

25. A drive assembly for a motorcycle comprising:
a drive sprocket having an input component adapted for engagement with the output shaft from an engine;
said drive component having an output component adapted for engagement with a mechanical clutch capable of communicating or interrupting engine power from said output shaft to a transmission;
centrifugal means to progressively engage said input component to said output component as said output shaft rises above a threshold rotational speed, and, to disengage said input component from said output component when said rotational speed equals or falls below said threshold speed; and
whereby said drive assembly interrupts communication of power from said engine to said mechanical clutch when said engine is at or below said threshold rotational speed, thereby alleviating the need to hold said mechanical clutch in a position to disengage engine power from said transmission.

26. A drive assembly for a vehicle comprising:
a drive sprocket having an input component adapted for engagement with the output shaft from an engine;
said drive component having an output component adapted for engagement with a mechanical clutch capable of communicating or interrupting engine power from said output shaft to a transmission;
centrifugal means to progressively engage said input component to said output component as said output shaft rises above a threshold rotational speed, and, to disengage said input component from said output component when said rotational speed equals or falls below said threshold speed; and
whereby said drive assembly interrupts communication of power from said engine to said mechanical clutch when said engine is at or below said threshold rotational speed, thereby alleviating the need to hold said mechanical clutch in a position to disengage engine power from said transmission.
